(19) United States
(12) Patent Application Publication
(10) Pub. No.: US 2002/0016878 A1
(43) Pub. Date: Feb. 7, 2002

(54) Technique for guaranteeing the availability of per thread storage in a distributed computing environment

(76) Inventor: Jose L. Flores, Austin, TX (US)

Correspondence Address: John J. Bruckner, Fulbright & Jaworski L.L.P., Suite 2400, 600 Congress Avenue, Austin, TX, 78701, US

(21) Appl. No.: 09/912,833

(22) Filed: Jul. 25, 2001

Related U.S. Application Data
(63) Continuation-in-part of application No. 60/220,974, filed on Jul. 26, 2000.
(63) Continuation-in-part of application No. 60/220,748, filed on Jul. 26, 2000.

(51) Int. Cl. G06F 12/00; G06F 12/14

(52) U.S. Cl. 710/200

(57) ABSTRACT

Systems and methods are described for guaranteeing the availability of per thread storage in a distributed computing environment.

### CROSS-REFERENCES TO RELATED APPLICATIONS

This application is a continuation-in-part of, and claims a benefit of priority under 35 U.S.C. 119(e) and/or 35 U.S.C. 120 from, copending U.S. Ser. No. 60/220,974, filed Jul. 26, 2000, and 60/220,748, filed Jul. 26, 2000, the entire contents of both of which are hereby expressly incorporated by reference for all purposes.

### BACKGROUND OF THE INVENTION

1. Field of the Invention

The invention relates generally to the field of software synchronization in a multitasking environment. More particularly, the invention relates to providing per thread storage in a distributed computing environment wherein nodes share at least one storage resource.

2. Discussion of the Related Art

Most modem multitasking operating systems feature thread execution using a system defined thread data structure. Within this thread data structure are various fields defining a variety of properties and states of the thread. Storage for this structure is typically not shared with other threads. Operating systems often also provide some form of additional per thread storage for use both internally by the operating system and for external consumption by third party applications. Such storage is extremely valuable for making implicit assumptions of relationships between the thread that owns the thread local storage (TLS) and many application-defined data structures that are referenced within this additional TLS.

Unfortunately, a large number of operating systems offer no storage for kernel applications. Further, if any storage is provided, the implementations use memory local to the node that the operating system is running on as storage for both the thread structure and the application-defined per-thread storage. As a result, access to this storage is limited to the node that allocated the storage for the locally running thread. Obviously, these implementations will not provide an acceptable type of per thread storage for multiple nodes in a distributed computing environment to individually access.

Heretofore, the requirement of a globally accessible thread local storage referred to above has not been fully met. What is needed is a solution that addresses this requirement.

### SUMMARY OF THE INVENTION

There is a need for the following embodiments. Of course, the invention is not limited to these embodiments.

According to an aspect of the invention, a method comprises: detecting creation of a thread, the thread running on a processor that is part of a distributed computing environment; after detecting the creation of the thread, receiving a request from a requesting software to allocate a thread local storage associated with the thread; scanning a data structure for a smallest suitable class size, the data structure including a list of thread local storage address size classes, each thread local storage address size class having a plurality of thread local storage addresses; determining whether the smallest suitable size class is found; if the smallest suitable size class is found, determining whether thread local storage of the smallest suitable size class is available; if the smallest suitable size class is found, and if thread local storage of the smallest suitable size class is available, selecting a thread local storage address from among those thread local storage addresses belonging to the smallest suitable size class; and if the smallest suitable size class is found, and if thread local storage of the smallest suitable size class is available, returning the thread local storage address to the requesting software. According to another aspect of the invention, a method comprises: detecting destruction of a thread, the thread running on a processor that is part of a distributed computing environment; after detecting the destruction of the thread, receiving a request from a requesting software to deallocate a thread local storage associated with the thread; scanning a data structure for a smallest suitable size class, the data structure including a list of thread local storage address size classes, each thread local storage address size class having a plurality of thread local storage addresses; determining whether the smallest suitable size class is found; if the smallest suitable size class is found, determining whether thread local storage of the smallest suitable size class is available; if the smallest suitable size class is found, and if thread local storage of the smallest suitable size class is available, creating a new entry of the smallest suitable size class; if the smallest suitable size class is found, and if thread local storage of the smallest suitable size class is available, denoting the new entry in a thread local storage address of the smallest suitable size class; and if the smallest suitable size class is found, and if thread local storage of the smallest suitable size class is available, inserting the new entry into the data structure. According to another aspect of the invention, a method, comprises: receiving a request from a requesting thread for a thread local storage address, the thread local storage address belonging to an owning thread running on a processor that is part of a distributed computing environment; searching a data structure for the thread local storage address using a code identifying the owning thread; and returning the thread local storage address, that belongs to the owning thread, to the requesting thread. According to another aspect of the invention, an apparatus comprises: a processor; and a private memory coupled to the processor, the private memory including a data structure having a list of thread local storage address size classes wherein each thread local storage address size class includes a plurality of thread local storage addresses.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore nonlimiting, embodiments illustrated in the drawings, wherein like reference numerals (if they occur in more than one view) designate the same elements. The invention may be better understood by reference to one or more of these drawings in combination with the description presented herein. It should be noted that the features illustrated in the drawings are not necessarily drawn to scale.

FIG. 1 illustrates a block diagram a computing environment, representing an embodiment of the invention.

FIG. 2 illustrates a software subsystem, representing an embodiment of the invention.

FIG. 3 illustrates a flow diagram of a process that can be implemented by a computer program, representing an embodiment of the invention.

FIG. 4 illustrates another flow diagram of a process that can be implemented by a computer program, representing an embodiment of the invention.

FIG. 5 illustrates another flow diagram of a process that can be implemented by a computer program, representing an embodiment of the invention.

### DESCRIPTION OF PREFERRED EMBODIMENTS

The invention and the various features and advantageous details thereof are explained more fully with reference to the nonlimiting embodiments that are illustrated in the accompanying drawings and detailed in the following description. Descriptions of well known components and processing techniques are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this detailed description.

The below-referenced U.S. Patent Applications disclose embodiments that were satisfactory for the purposes for which they are intended. The entire contents of U.S. Ser. No. 09/273,430, filed Mar. 19, 1999; 09/859,193, filed May 15, 2001; 09/854,351, filed May 10, 2001; 09/672,909, filed Sep. 28, 2000; 09/653,189, filed Aug. 31, 2000; 09/652,815, filed Aug. 31, 2000; 09/653,183, filed Aug. 31, 2000; 09/653,425, filed Aug. 31, 2000; 09/653,421, filed Aug. 31, 2000; 09/653,557, filed Aug. 31, 2000; 09/653,475, filed Aug. 31, 2000; 09/653,429, filed Aug. 31, 2000; 09/653,502, filed Aug. 31, 2000; ______ (Attorney Docket No. TNSY:017US), filed Jul. 25, 2001; ______ (Attorney Docket No. TNSY:018US), filed Jul. 25, 2001; ______ (Attorney Docket No. TNSY:019US), filed Jul. 25, 2001; ______ (Attorney Docket No. TNSY:020US), filed Jul. 25, 2001; ______ (Attorney Docket No. TNSY:021US), filed Jul. 25, 2001; ______ (Attorney Docket No. TNSY:022US), filed Jul. 25, 2001; ______ (Attorney Docket No. TNSY:023US), filed Jul. 25, 2001; and ______ (Attorney Docket No. TNSY:024US), filed Jul. 25, 2001; are hereby expressly incorporated by reference herein for all purposes.

The context of the invention can include shared resource distributed computing environments, such as multiprocessor parallel processing systems with shared memory nodes.

The invention discloses methods and apparatus to ensure an arbitrary amount of storage is allocated for exclusive use of exactly one thread which runs on a processor which is one of many processors within a distributed computing environment (DCE). The invention utilizes any type of resource simultaneously accessible to all nodes within the DCE as a storage device. This resource can include shared memory, traditional disc storage, or a type of media not yet in production.

Goals of the invention include: reducing storage allocation overhead time for data structures that are implicitly tied to exactly one thread, efficiently returning an address of a thread's TLS when presented with a thread ID, providing storage that is accessible to any node within the team, and reducing contention among processors for shared data structures.

There are many ways to reduce storage allocation overhead time for data structures that are characteristic of a single thread. The algorithm for reducing latency depends highly on how and when clients will use the thread local storage. Thread creation is typically a fairly expensive and infrequent operation. Therefore allocating TLS at the time of an owning thread's creation is ideal for systems with reasonably sized storage pools. On systems with a tighter memory requirement, allocation for TLS may be implemented in an on-demand method. Such systems sacrifice allocation latency for a smaller memory footprint.

Keeping in mind that most applications are written with the assumption that thread creation is a relatively expensive process, our implementation currently allocates a segment of both local and shared memory storage at the time of the thread's creation. For added speed of allocation, both the local and shared storage are first attempted as allocation off of a list of fixed size structures (i.e., a “look aside” list). If this allocation fails, then a normal, kernel allocation is executed. Thereafter, both the local and shared storage spaces are available for immediate use throughout the thread's running lifetime.

Regardless of the memory size of the system, releasing previously allocated TLS at the time of a thread's destruction is a preferred implementation. The current implementation of this invention runs on Windows NT based systems. NT provides a method for third party software to register callback routines to be invoked upon a thread's creation and destruction via the kernel routine PsSetCreateThreadNotifyRoutine( ). In a system without such callbacks, the same effect can easily be achieved by intercepting calls to the operating system's thread creation and destruction routines.

Returning a thread's TLS address is best implemented when taking into consideration how the operating system identifies its private thread structures in order to minimize overhead of mapping a thread's ID to its private storage area. Highly efficient methods include allocating more storage than the operating system would normally use for the thread and treating the extra storage as TLS, or hanging a pointer to independently allocated storage off of one of the field in the thread structure. These methods involve only a simple addition operation and possibly a pointer deference. Unfortunately, such elegant lookups are not feasible in every operating system. In this case, traditional lookups such as hashing or array lookups may be employed. Our Windows NT implementation may be configured to use either of two lookup methods. The non-portable method uses an offset into the kernel's KTHREAD structure to store a pointer to a representation of our privately allocated TLS. This in turn points to both local and shared TLS. The portable method uses a hash table keyed off of the value of the thread ID. Because the table is currently 64K of length and thread IDs almost never have values of over 0×FFFF, it is large enough to provide essentially a one to one mapping between all thread IDs in the system and buckets in the hash table. However, this method does allow for unlikely collisions by simply doing a linear search forward into the hash table until an unused entry is found.

Global access to a thread's TLS is completely dependent on the thread running on a node that is a member of a distributed computing environment wherein nodes share at least one storage source. Given this fact, storage for the thread is allocated in a manner very similar to that of a traditional single-node environment except that the TLS is backed by one or more of the shared storage resources. Our implementation uses a Shared Memory Node (SMN) to provide this storage. This memory appears to each node within the team as essentially an additional memory bank that is accessible via loads/stores and DMA transfers. Each node is connected to the SMN via an interconnect as described in U.S. Ser. No. 09/273,430, filed Mar. 19, 1999.

In order to achieve zero contention for the data contained in and referenced by TLS, access to the TLS by a thread other than the owning thread must be limited to times when it is implicitly known that the thread owning the storage is neither in a ready nor running state. An example of this would be when a thread's storage is touched as a result of traversing the queue hanging off of a synchronization object that the thread is waiting on. Our implementation reduces contention during TLS initialization by allocating storage off of a private look aside list as described above. Runtime contention is zero due to the fact that the TLS is private to a thread at all times that the thread is in a runable/schedulable state and may only be accessed in a context outside of the thread it is bound to when the owning thread is put into a sleeping or blocked state.

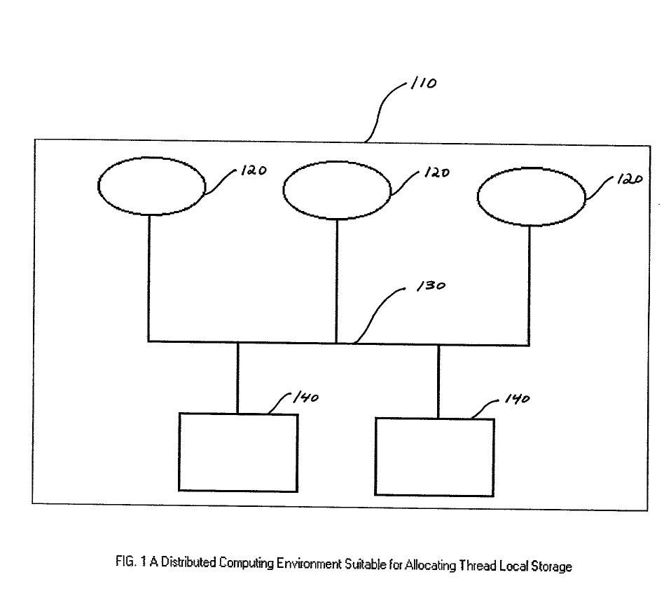

Referring to FIG. 1, a distributed computing environment 110 suitable for allocating TLS is shown. A plurality of processors 120 can be coupled in parallel to a plurality of shared memory nodes 140 via interconnects 130. The interconnects may include a member selected from the group consisting of optical signal carriers, wireless signal carriers and hardwire connections.

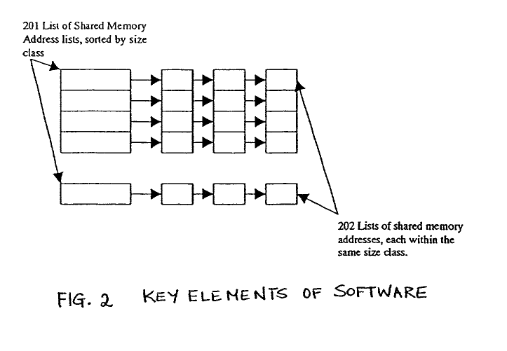

FIG. 2 shows a representation of the key elements of a software subsystem described herein. With reference thereto, element 201 is a data structure that maintains a list of memory allocation size classes, and within each class, element 202 is a list of available shared memory allocation addresses that may be used to satisfy a TLS allocation request. This data structure is stored in the private memory of each CPU, and hence access to this data structure does not need to be synchronized with the other CPUs in the computer system.

Referring again to FIG. 2, a data structure containing a list of shared memory address size classes 201 is shown. Each shared memory address size class 201 further contains a list of shared memory addresses 202 which belong to the same shared memory address size class 201. There are many different algorithms that one skilled in the art can use to implement the data structures shown in FIG. 2 and the key functions described above. Algorithms include, but are not limited to, singly linked lists, doubly linked lists, binary trees, queues, tables, arrays, sorted arrays, stacks, heaps, and circular linked lists. For purposes of describing the functionality of the invention, a Sorted Array of Lists is used, i.e., size classes are contained in a sorted array, each size class maintaining a list of shared memory addresses that can satisfy an allocation request of any length within that size class.

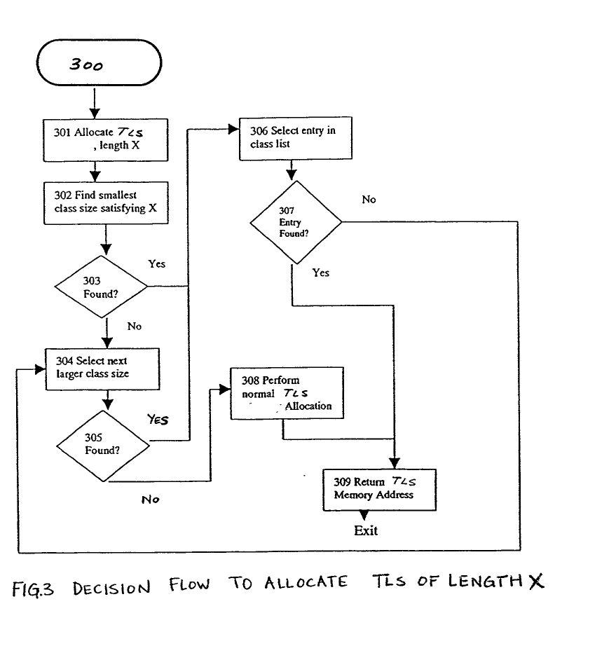

Referring to FIG. 3, a decision flow for allocating TLS of length X is shown. The decision flow is entered when a processor detects creation of a new thread 300 and receives a request from software to allocate TLS of length X 301. Upon receiving the request for TLS, control passes to a function to find a smallest size class satisfying the length X 302, as requested by software. The processor searches for a smallest suitable size class by scanning a data structure of the type shown in FIG. 2. The processor then determines whether a smallest suitable size class has been found 303. If a smallest suitable size class is found, the processor selects an entry in the smallest suitable size class 306. If the entry in the smallest suitable size class is found, the processor returns a TLS address to the requesting software 309. If the entry in the smallest suitable size class is not found, or if the smallest suitable size class is not found, the processor scans a data structure of the type shown in FIG. 2 for a next larger size class 304. The processor then determines whether a next larger size class has been found 305. If a next larger size class is found, then the processor selects an entry in the next larger size class 306. If the entry in the next larger size class is found, then the processor returns a TLS address to the requesting software 309. If the entry in the next larger size class is not found, the processor searches for yet another next larger size class. When no next larger size classes are found, the processor performs normal TLS allocation 308, and returns a TLS address to the requesting software 309.

FIG. 3 shows a decision flow of an application attempting to allocate TLS. With reference thereto, upon detecting creation of a new thread 300, element 301 is the actual function call the application makes. There are various parameters associated with this call, but for the purposes of this invention, the length of TLS is the key element. However, it is obvious to one skilled in the art that numerous sets of data structures as shown in FIG. 2 may be kept, each with one or more distinct characteristics described by one or more of the parameters passed to the allocation function itself. These characteristics include, but are not limited to, exclusive versus shared use, cached versus non-cached shared memory, memory ownership flags, etc.

Element 302 implements the scan of the sorted array, locating the smallest size class in the array that is greater than or equal to the length “X”, requested. (e.g. if X was 418, and three adjacent entries in the sorted array contained 256, 512, and 1024, then the entry corresponding to 512 is scanned first, since all TLS address locations stored in that class are of greater length than 418. In this example, using 256 produced undefined results, and using 1024 wastes shared memory resources.)

Element 303 is a decision of whether a size class was found in the array that represented TLS areas greater than or equal to X. If an appropriate size class is located, then element 306 is the function that selects an available address from the class list to satisfy the TLS request. If an entry is found, that address is removed from the list, and element 309 provides the selected TLS address to the calling application.

Element 304 is the function that selects the next larger size class from the previously selected class size, to satisfy the request for TLS. If there is no larger size class available, the normal TLS allocation mechanism shown in element 308 is invoked, which then returns the newly allocated TLS address to the calling function by element 309. Element 308 includes all of the synchronization and potential contention described above, but the intent of this invention is to satisfy as many TLS allocation requests through element 306 as possible, thereby reducing contention as much as possible. If in fact no TLS allocation request is ever satisfied by element 306, then a negligible amount of system overhead, and no additional contention is introduced by this invention. Therefore, in a worst case scenario, overall system performance is basically unaffected, but with a best case possibility of reducing TLS data structure contention to almost zero.

It is obvious to one skilled in the art that certain enhancements could be made to the data flow described in FIG. 3, including, but not limited to, directly moving from element 303 to element 308 if no size class was found, as well as using binary searches, hashes, b-trees, and other performance related algorithms to minimize the system overhead of trying to satisfy a request from element 301 up through element 309.

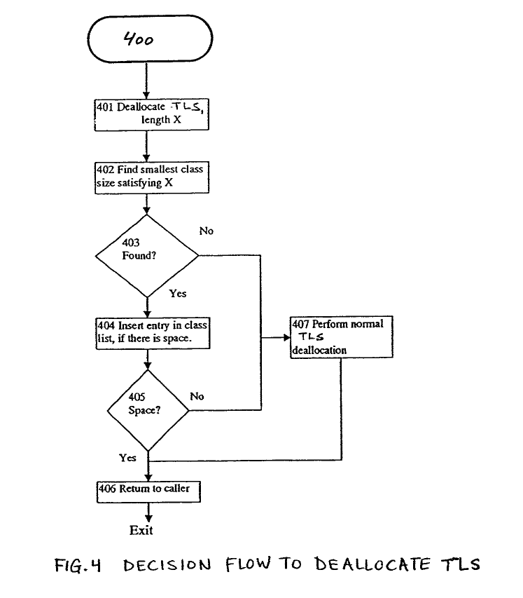

Referring to FIG. 4, a decision flow for deallocating TLS of length X is shown. The decision flow is entered when a processor detects destruction of a thread 400 and receives a request from software to deallocate TLS of length X 401. Upon receiving the request for deallocation of TLS, control passes to a function to find a smallest size class satisfying the length X 402. The processor then searches for a smallest suitable size class by scanning a data structure of the type shown in FIG. 2. The processor then determines whether a smallest suitable size class has been found 403. If a smallest suitable size class is found and if there are enough system resources available 405, the processor inserts a new entry into a size class list 404, contained in a data structure of the type shown in FIG. 2. If sufficient system resources are not available, or if a smallest size class is not found, the processor performs normal TLS deallocation 407, bypassing use of a data structure to reduce contention for access to shared resources. If there are sufficient resources available, the program returns control to a caller 406.

FIG. 4 shows a decision flow of an application attempting to deallocate TLS. With reference thereto, after detecting destruction of a thread 400, element 401 is the actual function call the application makes. There are various parameters associated with this call, but for the purposes of this invention, the length of TLS is the key element. The length may not actually be passed with the function call, yet accessing the shared memory data structure in a Read Only fashion will yield the length of the memory segment, and usually, no contention is encountered while accessing this information. It is obvious to one skilled in the art that numerous sets of data structures as shown in FIG. 2 may be kept, each with one or more distinct characteristics described by one or more of the parameters passed to the deallocation function itself. These characteristics include, but are not limited to, exclusive versus shared use, cached versus non-cached shared memory, memory ownership flags, etc.

Element 402 implements the scan of the sorted array, locating the largest size class in the array that is less than or equal to the length “X”, requested. (e.g. if X was 718, and three adjacent entries in the sorted array contained 256, 512, and 1024, then the entry corresponding to 512 is used, since all TLS address locations stored in that class are of length greater than 512. In this example using 256 wastes shared memory resources, and using 1024 produces undefined results.)

Element 403 determines if an appropriate size class was found. It is obvious to one skilled in the art that dynamically creating new size class lists is feasible, but for the purposes of this discussion, we shall assume the size class list is complete enough such that storing entries for larger class sizes in each CPU of the computer system might be detrimental to overall system performance by reducing available TLS resources in the extreme. In these cases, when very large TLS regions are released to global shared memory, they should be returned to the available pool of TLS immediately, rather than being managed in private memory spaces of each CPU. Computer system characteristics and configurations are used to determine the largest size class managed in the private memory of each CPU, but an example of a complete list of class sizes includes, but is not limited to: 64, 128, 256, 512, 1024, 2048, 4096, 8192, 16384, 32768, and 65536.

Element 404 inserts the entry into the selected size class list, provided there is room left for the insertion. Room may not be left in the size class lists if they are implemented as fixed length arrays, and all the available spaces in the array are occupied. Also, the size class lists may be artificially trimmed to maintain a dynamically determined amount of TLS based on one or more of several criteria, including but not limited to: class size, size class usage counts, programmatically configured entry lengths or aggregate shared memory usage, etc.

Element 405 directs the flow of execution based on whether space was available for the insertion of the TLS address onto the list, or not. If space was available, the proceeding to element 406 returns control back to the calling application. If either element 403 or 405 determined a false result, then control is passed to element 407. Element 407 includes all of the synchronization and potential contention described above, but the intent of this invention is to be able to satisfy as many TLS deallocation requests through element 405 as possible, thereby reducing contention as much as possible. If no TLS deallocation request were ever satisfied by element 403 or 405, then only a negligible amount of system overhead and no additional contention would be introduced by the invention.

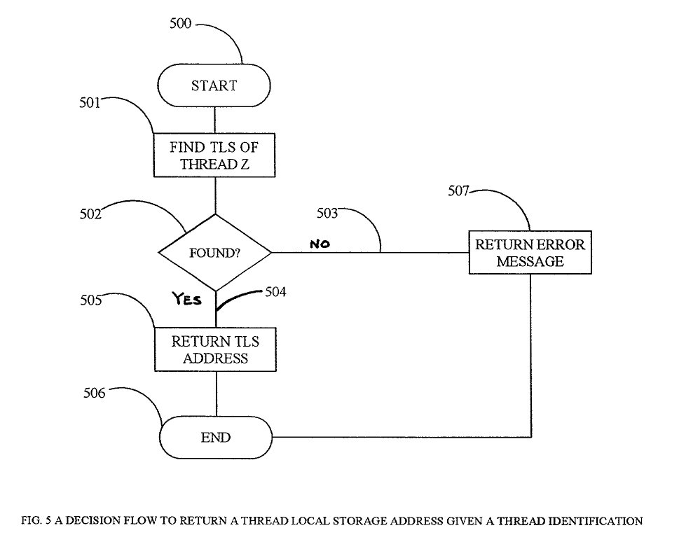

Referring to FIG. 5, a decision flow to return a thread local address given a thread identification is shown. The decision flow is entered via a subroutine START 500. A prompt to find a TLS address of an owning thread Z 501 is initiated when a thread running on a processor within a distributed computing environment requires access to the TLS of thread Z, thread Z being another thread running on a processor in the same distributed computing environment (an example of a suitable distributed computing environment is shown in FIG. 1). Control then passes to a function to scan a data structure containing thread local storage addresses for various owning threads for a thread local address that belongs to thread Z 502. If a matching thread local storage address is found 504, the thread local storage address is returned to a requesting thread 505. The decision flow is thus completed and control is passed back to a caller 506. If a matching thread local storage address is not found 503, an error message is returned 507, and control is passed back to the caller 506.

The invention can also be included in a kit. The kit can include some, or all, of the components that compose the invention. The kit can be an in-the-field retrofit kit to improve existing systems that are capable of incorporating the invention. The kit can include software, firmware and/or hardware for carrying out the invention. The kit can also contain instructions for practicing the invention. Unless otherwise specified, the components, software, firmware, hardware and/or instructions of the kit can be the same as those used in the invention.

The term approximately, as used herein, is defined as at least close to a given value (e.g., preferably within 10% of, more preferably within 1% of, and most preferably within 0.1% of). The term substantially, as used herein, is defined as at least approaching a given state (e.g., preferably within 10% of, more preferably within 1% of, and most preferably within 0.1% of). The term coupled, as used herein, is defined as connected, although not necessarily directly, and not necessarily mechanically. The term deploying, as used herein, is defined as designing, building, shipping, installing and/or operating. The term means, as used herein, is defined as hardware, firmware and/or software for achieving a result. The term program or phrase computer program, as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system. The terms including and/or having, as used herein, are defined as comprising (i.e., open language). The terms a or an, as used herein, are defined as one or more than one. The term another, as used herein, is defined as at least a second or more.

### Practical Applications of the Invention

A practical application of the invention that has value within the technological arts is in multiple CPU shared resource environments requiring multiple threads to access a single thread local storage address. Further, the invention is useful in conjunction with shared memory units (such as are used for the purpose of network databases), or the like. There are virtually innumerable uses for the invention, all of which need not be detailed here.

### Advantages of the Invention

A technique for guaranteeing the availability of per thread storage in a distributed computing environment, representing an embodiment of the invention, can be cost effective and advantageous for at least the following reasons. The invention improves quality and/or reduces costs compared to previous approaches. The invention allows multiple threads running on multiple processors in a distributed computing environment to efficiently access data structures containing information particular to each thread running within the distributed computing environment.

All the disclosed embodiments of the invention disclosed herein can be made and used without undue experimentation in light of the disclosure. Although the best mode of carrying out the invention contemplated by the inventor) is disclosed, practice of the invention is not limited thereto. Accordingly, it will be appreciated by those skilled in the art that the invention may be practiced otherwise than as specifically described herein.

Further, the individual components need not be formed in the disclosed shapes, or combined in the disclosed configurations, but could be provided in virtually any shapes, and/or combined in virtually any configuration. Further, the individual components need not be fabricated from the disclosed materials, but could be fabricated from virtually any suitable materials.

Further, variation may be made in the steps or in the sequence of steps composing methods described herein.

Furthermore, all the disclosed elements and features of each disclosed embodiment can be combined with, or substituted for, the disclosed elements and features of every other disclosed embodiment except where such elements or features are mutually exclusive.

It will be manifest that various substitutions, modifications, additions and/or rearrangements of the features of the invention may be made without deviating from the spirit and/or scope of the underlying inventive concept. It is deemed that the spirit and/or scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for” Subgeneric embodiments of the invention are delineated by the appended independent claims and their equivalents. Specific embodiments of the invention are differentiated by the appended dependent claims and their equivalents.

What is claimed is:

1. A method, comprising:
detecting creation of a thread, the thread running on a processor that is part of a distributed computing environment;
after detecting the creation of the thread, receiving a request from a requesting software to allocate a thread local storage associated with the thread;
scanning a data structure for a smallest suitable class size, the data structure including a list of thread local storage address size classes, each thread local storage address size class having a plurality of thread local storage addresses;
determining whether the smallest suitable size class is found;
if the smallest suitable size class is found, determining whether thread local storage of the smallest suitable size class is available;
if the smallest suitable size class is found, and if thread local storage of the smallest suitable size class is available, selecting a thread local storage address from among those thread local storage addresses belonging to the smallest suitable size class; and
if the smallest suitable size class is found, and if thread local storage of the smallest suitable size class is available, returning the thread local storage address to the requesting software.

2. The method of claim 1, wherein the data structure is resident in a private memory of each processor in a multiprocessor configuration.

3. The method of claim 1, further comprising: if the smallest suitable size class is not found,
scanning the data structure for a next larger suitable size class;
determining whether the next larger suitable size class has been found;
if the next larger suitable size class is found, selecting a thread local storage address from the next larger suitable size class; and
if the next larger suitable size class is found, returning the thread local storage address to the requesting software.

4. A method, comprising:
detecting destruction of a thread, the thread running on a processor that is part of a distributed computing environment;
after detecting the destruction of the thread, receiving a request from a requesting software to deallocate a thread local storage associated with the thread;
scanning a data structure for a smallest suitable size class, the data structure including a list of thread local storage address size classes, each thread local storage address size class having a plurality of thread local storage addresses;
determining whether the smallest suitable size class is found;
if the smallest suitable size class is found, determining whether thread local storage of the smallest suitable size class is available;
if the smallest suitable size class is found, and if thread local storage of the smallest suitable size class is available, creating a new entry of the smallest suitable size class;
if the smallest suitable size class is found, and if thread local storage of the smallest suitable size class is available, denoting the new entry in a thread local storage address of the smallest suitable size class; and
if the smallest suitable size class is found, and if thread local storage of the smallest suitable size class is available, inserting the new entry into the data structure.

5. The method of claim 4, further comprising deallocating the thread local storage without inserting the new entry into the data structure, if a smallest suitable size class is not found, or if thread local storage of the smallest suitable size class is not available.

6. A method, comprising:
receiving a request from a requesting thread for a thread local storage address, the thread local storage address belonging to an owning thread running on a processor that is part of a distributed computing environment;
searching a data structure for the thread local storage address using a code identifying the owning thread; and
returning the thread local storage address, that belongs to the owning thread, to the requesting thread.

7. The method of claim 6, wherein the data structure is resident in a shared memory unit.

8. An apparatus, comprising:
a processor; and
a private memory coupled to the processor, the private memory including a data structure having a list of thread local storage address size classes wherein each thread local storage address size class includes a plurality of thread local storage addresses.

9. The apparatus of claim 8, wherein the processor includes a device selected from the group consisting of microprocessors, programmable logic devices, and microcontrollers.

10. The apparatus of claim 8, further comprising another processor coupled to the processor.

11. The apparatus of claim 8, further comprising:
a global shared memory coupled to the processor, the global shared memory including another data structure having another list of thread local storage address size classes.

12. The apparatus of claim 11, wherein the global shared memory can be accessed by a plurality of processors.

13. The apparatus of claim 8, wherein the private memory can be accessed by a plurality of processors.

14. The apparatus of claim 8, wherein the data structure includes at least one member selected from the group consisting of singly linked lists, doubly linked lists, binary trees, queues, tables, arrays, sorted arrays, stacks, heaps, and circular linked lists.

15. The apparatus of claim 11, wherein the data structure includes at least one member selected from the group consisting of singly linked lists, doubly linked lists, binary trees, queues, tables, arrays, sorted arrays, stacks, heaps, and circular linked lists.
